(19) United States
(12) Patent Application Publication
(10) Pub. No.: US 2026/0276797 A1
(43) Pub. Date: Sep. 17, 2026

(54) SYSTEMS AND METHODS FOR SENSOR CALIBRATION IN A NON-CONTROLLED ENVIRONMENT

(71) Applicant: Torc Robotics, Inc., Blacksburg, VA (US)

(72) Inventors: Sebastian Beckmann, Stuttgart (DE); Stefan Oexl, Stuttgart (DE); Roman Keller, Denkendorf (DE)

(21) Appl. No.: 19/076,053

(22) Filed: Mar. 11, 2025

(51) Int. Cl. G01S 7/497; G01S 7/40; G01S 13/931; G01S 17/931

(52) U.S. Cl. CPC G01S 7/497; G01S 7/40; G01S 13/931; G01S 17/931

(57) ABSTRACT

A system for calibration of vehicle sensors can include a first plurality of sensors of a first vehicle to sense a surrounding of the first vehicle and a processing device in communication with the first plurality of sensors. The processing device can receive a first set of sensor data acquired by the first plurality of sensors while the first vehicle is stationary in a hub, receive a second set of sensor data acquired by a second plurality of sensors of a second vehicle while the second vehicle is stationary in the hub, receive a third set of sensor data acquired by a third plurality of sensors of a third vehicle while the third vehicle is stationary in the hub, compare the first set of sensor data to the second and third sets of sensor data, and determine, based on the comparison, whether to calibrate the first plurality of sensors.

### TECHNICAL FIELD

The field of the disclosure relates to calibration of vehicle sensors in a non-controlled environment, and more specifically, to calibration of vehicle sensors using available outside sensors in a hub or other environment.

### BACKGROUND

Modern vehicles, and in particular autonomous and semi-autonomous vehicles, include a variety of sensors to perceive their surroundings. The sensors are critical components especially for autonomous and semi-autonomous vehicles, because they act as the “eyes” and “ears” of the corresponding vehicles. In particular, the sensors provide, via respective sensing techniques, various perceptions of the surroundings or environment of the vehicle to enable various driver-assistance features and/or self-driving features. Sensors installed in a modern vehicle regularly monitor a variety of operating parameters of the vehicle and the surrounding area where the vehicle is operating or parked. Such parameters can include, e.g., engine temperature, oil pressure, tire pressure, vehicle speed, as well as the speed, distance, and relative position of objects around the vehicle. Sensor data collected by the vehicle sensors is typically communicated or otherwise provided to one or more processing devices or control units, such as the electronic control unit (ECU). The sensor data is used to make real-time adjustments or decisions related to the systems and operation of the vehicle.

With advancements in sensing technology and artificial intelligence, modern vehicles are equipped with a wide array of sensors to enable advanced driver-assistance systems (ADASs) and/or automated driving systems (ADSs). These systems rely mainly on sensor data provided by the sensors onboard the vehicle in decision making. As technology continues to evolve and vehicles become more automated, the role of sensors in modern vehicles becomes greater and more critical. In other words, the operation of modern vehicles, and automated vehicles in particular, depends on the reliability and accuracy of the sensors. For example, failure to accurately perceive the surroundings of an autonomous vehicle or failure to point the vehicle in the right direction could result in catastrophic accidents. Also, failure to detect defective or malfunctioning components in the vehicle can be costly.

Reliability and accuracy of onboard sensors requires effective configuration and calibration of the sensors. The sensor configuration step involves setting the proper parameters of the sensors during the production phase or when replacing a sensor on the vehicle. The sensor calibration step involves adjusting the sensors during the deployment phase of the vehicle to correct for any deviations in the sensor measurements. Deviations or offsets in sensor measurements can occur over time due to general sensor use or exposure of the sensor to various vehicle operating environments and associated operating factors, e.g. vibratory disturbances. Vehicles are able to be operated most efficiently and effectively when the sensors are accurately configured and calibrated. Therefore, there is a need to ensure that sensors are effectively and reliably calibrated and configured during the production and deployment phases of vehicle operation.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, an example system for calibration of vehicle sensors is provided. The system can include a first plurality of sensors of a first vehicle to sense a surrounding of the first vehicle, and a processing device in communication with the first plurality of sensors. The processing device can be configured to execute instructions stored in a memory to receive, from the first plurality of sensors of the first vehicle, a first set of sensor data acquired by the first plurality of sensors while the first vehicle is stationary in a hub, receive a second set of sensor data acquired by a second plurality of sensors of a second vehicle while the second vehicle is stationary in the hub, receive a third set of sensor data acquired by a third plurality of sensors of a third vehicle while the third vehicle is stationary in the hub, compare the first set of sensor data to the second and third sets of sensor data, and determine, based on the comparison, to calibrate at least one sensor of the first plurality of sensors using at least one of the second set of sensor data or the third set of sensor data. The first set of sensor data can provide a first representation of a hub environment of the hub as perceived by the first plurality of sensors. The second set of sensor data can provide a second representation of the hub environment as perceived by the second plurality of sensors. The third set of sensor data can provide a third representation of the hub environment as perceived by the third plurality of sensors.

In some implementations, the first representation of the hub environment can include a relative position of the second vehicle with respect to the first vehicle, a relative orientation of the second vehicle with respect to the first vehicle, a relative position of the third vehicle with respect to the first vehicle, and a relative orientation of the third vehicle with respect to the first vehicle.

In some implementations, the second representation of the hub environment can include a relative position of the first vehicle with respect to the second vehicle, a relative orientation of the first vehicle with respect to second vehicle, a relative position of the third vehicle with respect to the second vehicle, and a relative orientation of the third vehicle with respect to the second vehicle.

In some implementations, the third representation of the hub environment can include a relative position of the first vehicle with respect to the third vehicle, a relative orientation of the first vehicle with respect to the third vehicle, a relative position of the second vehicle with respect to the third vehicle, and a relative orientation of the second vehicle with respect to third vehicle.

In some implementations, the processing device can be configured to determine, using the first set of sensor data, a first relative position of the second vehicle with respect to the first vehicle, determine, using the first set of sensor data, a second relative position of the third vehicle with respect to the first vehicle, determine, using the second set of sensor data, a third relative position of the first vehicle with respect to the second vehicle, determine, using the third set of sensor data, a fourth relative position of the first vehicle with respect to the third vehicle, and compare the first relative position to the third relative position and the second relative position to the fourth relative position.

In some implementations, the processing device can be configured to determine, using the first set of sensor data, a first position of a stationary object of the hub with respect to the first vehicle, determine, using the second set of sensor data, a second position of the stationary object with respect to the second vehicle, determine, using the third set of sensor data, a third position of the stationary object with respect to the third vehicle, and compare the first position to the second and third positions of the stationary object.

In some implementations, the processing device can be configured to receive a fourth set of sensor data acquired by a fourth plurality of sensors of the hub, compare the first set of sensor data to the fourth set of sensor data, and determine, further based on comparing the first set of sensor data to the fourth set of sensor data, to calibrate the at least one sensor of the first plurality of sensors. The fourth set of sensor data can provide a fourth representation of the hub environment as perceived by the fourth plurality of sensors.

In some implementations, the fourth representation of the hub environment can include at least one of relative positions of the first, second and third vehicles with respect to each other, or relative positions of the first, second and third vehicles with respect to a stationary object in the hub.

In some implementations, the processing device can be configured to receive the second set of sensor data from a computer device of the hub, the computer device receiving the second set of sensor data from the second vehicle.

In some implementations, the first plurality of sensors can include at least one of one or more radar sensors, one or more light detection and raging (LiDAR) sensors, or one or more cameras.

In another aspect, an example method for calibrating vehicle sensors is provided. The method can include receiving, by a processing device of a first vehicle, from a first plurality of sensors of the first vehicle, a first set of sensor data acquired by the first plurality of sensors while the first vehicle is stationary in a hub, receiving, by the processing device, a second set of sensor data acquired by a second plurality of sensors of a second vehicle while the second vehicle is stationary in the hub, receiving, by the processing device, a third set of sensor data acquired by a third plurality of sensors of a third vehicle while the third vehicle is stationary in the hub, comparing, by the processing device, the first set of sensor data to the second and third sets of sensor data, and determining, by the processing device, based on the comparison, to calibrate at least one sensor of the first plurality of sensors using at least one of the second set of sensor data or the third set of sensor data. The first set of sensor data can provide a first representation of a hub environment of the hub as perceived by the first plurality of sensors. The second set of sensor data can provide a second representation of the hub environment as perceived by the second plurality of sensors. The third set of sensor data can provide a third representation of the hub environment as perceived by the third plurality of sensors.

In some implementations, the first representation of the hub environment can include a relative position of the second vehicle with respect to the first vehicle, a relative orientation of the second vehicle with respect to the first vehicle, a relative position of the third vehicle with respect to the first vehicle, and a relative orientation of the third vehicle with respect to the first vehicle.

In some implementations, the second representation of the hub environment can include a relative position of the first vehicle with respect to the second vehicle, a relative orientation of the first vehicle with respect to second vehicle, a relative position of the third vehicle with respect to the second vehicle, and a relative orientation of the third vehicle with respect to the second vehicle.

In some implementations, the third representation of the hub environment can include a relative position of the first vehicle with respect to the third vehicle, a relative orientation of the first vehicle with respect to the third vehicle, a relative position of the second vehicle with respect to the third vehicle, and a relative orientation of the second vehicle with respect to third vehicle.

In some implementations, the method can include determining, using the first set of sensor data, a first relative position of the second vehicle with respect to the first vehicle, determining, using the first set of sensor data, a second relative position of the third vehicle with respect to the first vehicle, determining, using the second set of sensor data, a third relative position of the first vehicle with respect to the second vehicle, determining, using the third set of sensor data, a fourth relative position of the first vehicle with respect to the third vehicle, and comparing the first relative position to the third relative position and the second relative position to the fourth relative position.

In some implementations, the method can include determining, using the first set of sensor data, a first position of a stationary object of the hub with respect to the first vehicle, determining, using the second set of sensor data, a second position of the stationary object with respect to the second vehicle, determining, using the third set of sensor data, a third position of the stationary object with respect to the third vehicle, and comparing the first position to the second and third positions of the stationary object.

In some implementations, the method can include receiving a fourth set of sensor data acquired by a fourth plurality of sensors of the hub, comparing the first set of sensor data to the fourth set of sensor data, and determining, further based on comparing the first set of sensor data to the fourth set of sensor data, to calibrate the at least one sensor of the first plurality of sensors. The fourth set of sensor data can provide a fourth representation of the hub environment as perceived by the fourth plurality of sensors.

In some implementations, the fourth representation of the hub environment can include at least one of relative positions of the first, second and third vehicles with respect to each other, or relative positions of the first, second and third vehicles with respect to a stationary object in the hub.

In some implementations, the processing device can be configured to receive the second set of sensor data from a computer device of the hub, the computer device receiving the second set of sensor data from the second vehicle.

In some implementations, the first plurality of sensors can include at least one of one or more radar sensors, one or more light detection and raging (LiDAR) sensors, or one or more cameras.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic perspective view of an autonomous truck.

FIG. 2 is a schematic perspective view of an autonomous truck and trailer.

FIG. 3 is a schematic side view of an autonomous truck and trailer.

FIG. 4 is a block diagram of the autonomous truck shown in FIGS. 1-3.

FIG. 5 is a block diagram of an example computing system.

FIG. 6 is a flowchart of a method for calibration of vehicle sensors, according to an example embodiment of the current disclosure.

FIG. 7 is a diagram depicting a first hub environment, according to an example embodiment of the current disclosure.

FIG. 8 is a diagram depicting a second hub environment, according to an example embodiment of the current disclosure.

FIG. 9 is a diagram depicting a third hub environment, according to an example embodiment of the current disclosure.

FIG. 10 is a diagram depicting a fourth hub environment, according to an example embodiment of the current disclosure.

FIG. 11 is a diagram depicting a fifth hub environment, according to an example embodiment of the current disclosure.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

As modern vehicles become more automated, the reliability and accuracy of vehicle sensors become increasingly important. In particular, the automated driving system (ADS) in an autonomous vehicle relies on the vehicle sensors to perceive or understand the surrounding or environment of the vehicle, and make proper decisions to automatically operate the vehicle. However, vehicle sensors become out of calibration over time due to various factors, such as daily normal use, changes in temperature, vibrations, vehicle part replacements and/or accidents. The miscalibration of the sensors causes the sensors to produce inaccurate sensor measurements or data. Inaccurate and/or unreliable sensor data, especially in autonomous or semi-autonomous vehicles, may yield vehicle safety issues or risks. For example, detecting another vehicle or object to be farther than it actually is from the ego vehicle can result in a collision. Furthermore, inaccurate sensing or detection of lane lines can lead to unintended driving across lane lines. Also, miscalibrated cameras can lead to failure to accurately sense, perceive and/or understand road signs, which can result in violations of driving rules.

As a result of the unavoidable and frequent miscalibration of vehicle sensors and the safety issues or risks associated with sensor miscalibration in autonomous or semi-autonomous vehicles, there is a need for a system and method that yield repeated and reliable calibrations or recalibrations of vehicle sensors. The reliable recalibration of vehicle sensors will ensure that reliable and accurate sensor data is consistently delivered. However, current sensor calibration processes can be time consuming and disruptive to normal use or normal operations of the vehicle. For example, some of the sensors of ego trucks and/or other ego vehicles are specifically calibrated after each trip. After a mission is completed, the next trip of the ego truck or ego vehicle may not be started until recalibration of the vehicle sensors is completed.

One common sensor calibration approach currently used is target-based calibration. Target-based calibration is typically performed in designated and controlled sites or locations with specific targets or obstacles placed at defined positions within the calibration sites or locations. For example, checkerboards can be placed at specific positions in a sensor calibration site or location. The checkerboards are then detected or sensed by sensors of a vehicle, as the vehicle moves through the calibration site. The vehicle sensors track or sense the targets, e.g., checkerboards, across different frames corresponding to different positions or locations of the vehicle, e.g., along a specific path. Sensor data recorded by the vehicle sensors is compared to expected or ground truth data and relevant calibration parameters are computed based on the comparison. For example, the positions or distances of the targets relative to multiple points on the path of the vehicle can be measured and compared to corresponding measurements acquired by the vehicle sensors to determine whether and how to calibrate the vehicle sensors. Also, images of the checkerboards captured by vehicle cameras at different angles and/or from different vehicle positions can be used to calibrate the vehicle cameras. For example, the captured images of the checkerboards can be used to accurately map real-world points of the checkerboards to their corresponding pixel locations in the images. Lens distortion, perspective effects and/or alignment of the cameras relative to the geometry of the vehicle can be adjusted or corrected based on the captured images and/or the mapping.

The above described calibration approach has various drawbacks. First, the process for completing sensor calibration in designated and controlled calibration sites takes a measurable amount of time and during the lengthy calibration process the vehicle is off road. In particular, scheduling vehicle sensor calibration in designated and controlled calibration sites typically imposes time delays. Additionally, it is expensive to set up and maintain a dedicated, controlled calibration site with specific calibration equipment. Furthermore, vehicles are typically calibrated one at a time to maintain a controlled environment, which makes the calibration process time consuming and inconvenient with respect to scheduling sensor calibration. It is to be noted that safety considerations call for sensor calibration at a desired frequency or after each ride to avoid risks associated with sensor miscalibration. The frequency of sensor calibration increases the demand for the designated and controlled calibration sites and makes the scheduling of calibration events more complex. Also, unavailability of calibration sites for a time period means non-operability of the vehicle during that time period.

Another current calibration approach involves using sensor data of an ego vehicle to detect or determine the distance to another vehicle or object. The detected distance is compared with the expected distance to vehicle/object based on location data gathered by the ego vehicle and/or other vehicles. The location data is typically determined based on data from global navigation satellite system (GNSS) receivers. However, the accuracy of GNSS receivers can range from two to ten meters. As such, the error in the expected distance can be greater two meters. Therefore, using the expected distance to calibrate vehicle sensors leads to inaccurate calibration of the vehicle sensors. Also, this calibration approach is limited to calibrating distance measurements by some of the vehicle sensors. For example, this calibration approach does not address camera calibration.

Embodiments described herein address the above technical problems associated with the calibration of vehicle sensors. Systems and methods described herein enable sensor calibration in non-controlled sites or locations, such as hubs. A vehicle can use sensor data available in a hub, e.g., sensor data from other vehicles in the hub or from hub sensors, to efficiently and effectively calibrate the vehicle sensors. The systems and methods described herein can be used in other types of non-controlled locations, e.g., other than hubs.

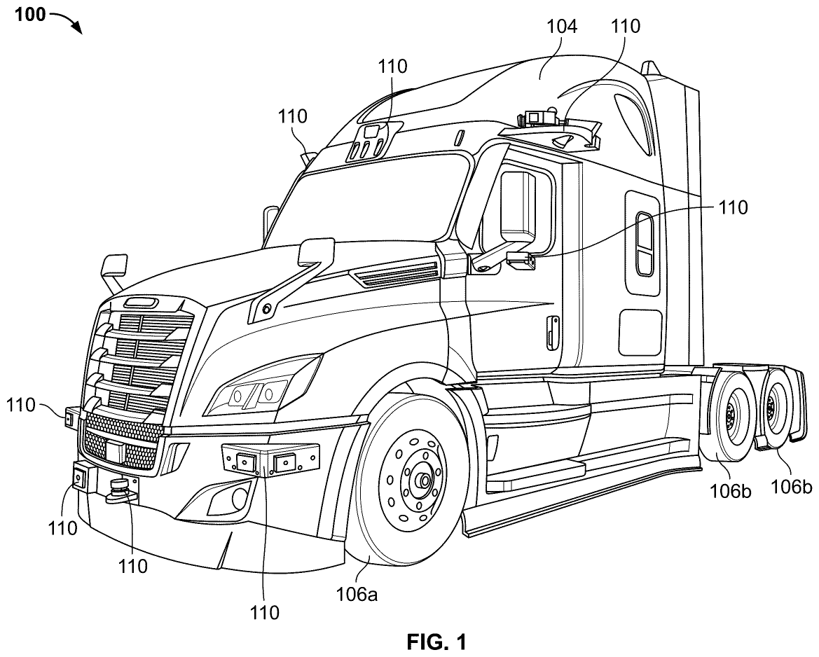

Various embodiments in the present disclosure are described with reference to FIG. 1-11 below.

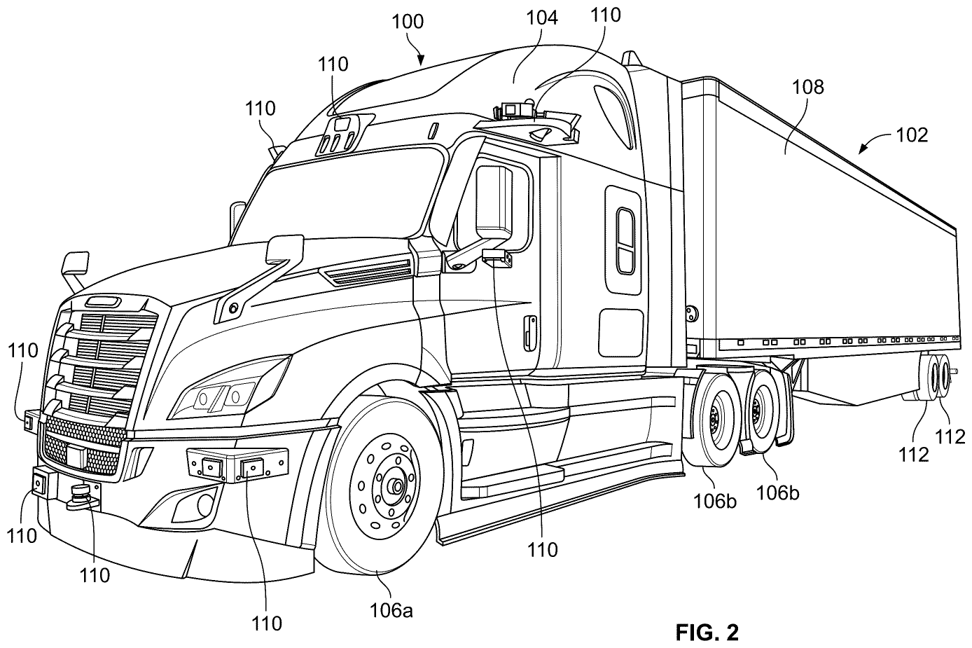

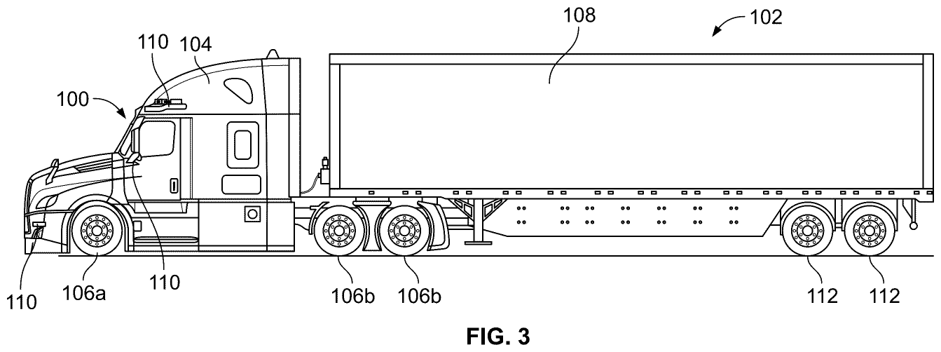

FIG. 1 is a perspective view of a vehicle 100, such as a truck that may be conventionally connected to a single or tandem trailer 102 to transport the trailer 102 to a desired location, as shown in FIGS. 2 and 3, which are, respectively, perspective and side views of the vehicle 100 of FIG. 1 with the trailer 102 attached thereto. The vehicle 100 includes a cabin 104 that can be supported, and steered in the required direction, by front wheels 106a and rear wheels 106b that are partially shown in FIG. 1. The front wheels 106a are positioned by a steering system that includes a steering wheel and a steering column (not shown). The steering wheel and the steering column may be located in the interior of cabin 104.

The vehicle 100 may be an autonomous vehicle, in which case the vehicle 100 may omit the steering wheel and the steering column to steer the vehicle 100. Rather, the vehicle 100 may be operated by an autonomy computing system of the vehicle 100 based on data collected by a sensor network including one or more sensors, e.g., sensors 110 shown in FIGS. 1-3. The vehicle 100 may additionally include a fifth-wheel coupling (not shown) to which the trailer 102 can be releasably attached. The trailer 102 can include a storage container 108 and a plurality of rear wheels 112 that support the storage container 108. It should be understood that in some embodiments the vehicle 100 and the trailer 102 can be a permanently attached as a single unit.

The sensors 110 have a field-of-view at the front, sides and/or rear of the vehicle 100. Similar sensors 110 can be used around the perimeter of the vehicle 100 to ensure full sensing environmental coverage around the vehicle 100 is provided by the sensors 110. In some embodiments, the vehicle 100 can include, e.g., 5-6 LIDAR sensors, 8-10 cameras, combinations thereof, or the like. In some embodiments, the vehicle 100 can tow a trailer 102 and the trailer 102 can similarly include LIDAR sensors and/or cameras to provide field-of-view coverage around the perimeter of the vehicle 100 and the trailer 102. The environmental coverage by the sensors and/or cameras therefore provides data corresponding with the front, rear, sides and corners of the vehicle 100 and the trailer 102 hauled by the vehicle 100.

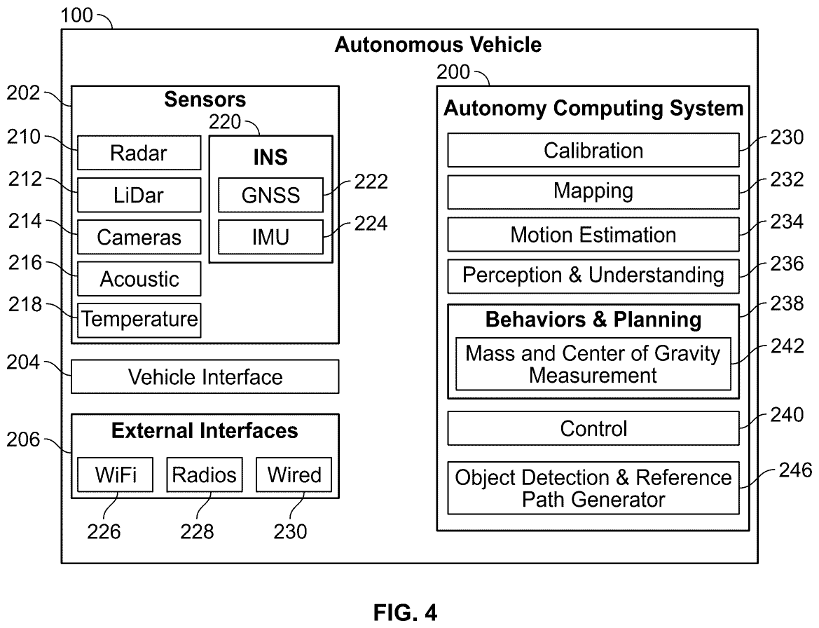

FIG. 4 is a block diagram representing autonomous vehicle 100 shown in FIGS. 1-3. In the example embodiment, autonomous vehicle 100 generally includes autonomy computing system 200, sensors 202, a vehicle interface 204, and external interfaces 206. It should be understood that the sensors 110 on the vehicle 100 in FIGS. 1-3 and described herein correspond to the sensors identified as 202 in FIG. 4. The sensors 110 may specifically comprise any of the sensors 210-220 shown in FIG. 4 and described herein.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers in the environment surrounding autonomous vehicle 100. In some embodiments, the image data generated by cameras 214 may be sent to autonomy computing system 200 or other aspects of autonomous vehicle 100 for one or more of identifying objects around the vehicle 100, updating a reference path based on the detected objects, and controlling operation of the vehicle 100 to guide the vehicle 100 along its route.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100. In some embodiments, the trailer associated with the vehicle 100 can include similar sensors 202 for gathering similar data associated with the trailer, thereby further assisting with control operations of the autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5G, Bluetooth, etc.).

In some embodiments, external interfaces 206 may be configured to communicate with an external network via a wired connection 226, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a mass and center of gravity measurement module 242, a control module or controller 240, and an object detection and reference path generator module 246. The object detection and reference path generator module 246, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

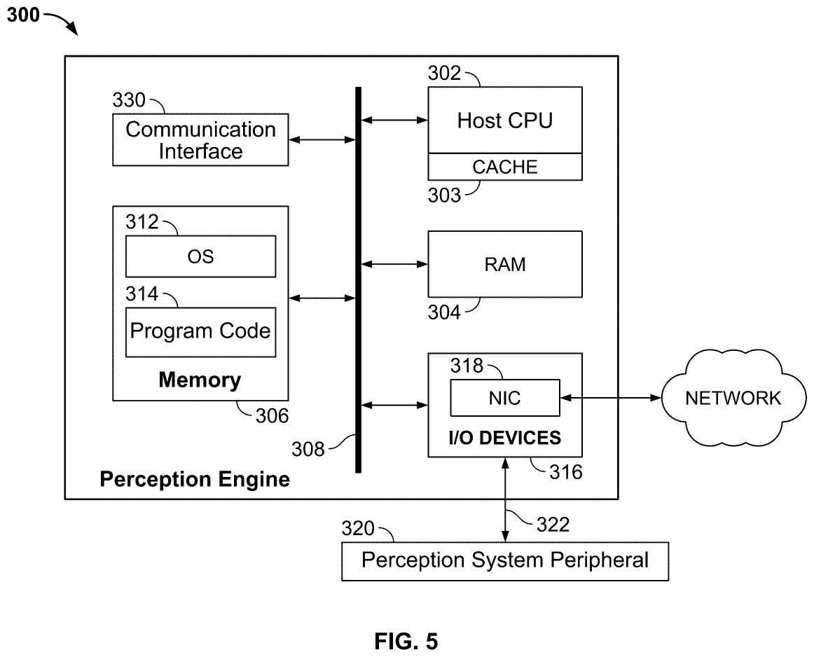

FIG. 5 is a block diagram of an example computing system 300, such as the autonomy computing system 200 shown in FIG. 4, configured for sensing an environment in which an autonomous vehicle is positioned. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 4. In alternative embodiments, one or more sections of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus.

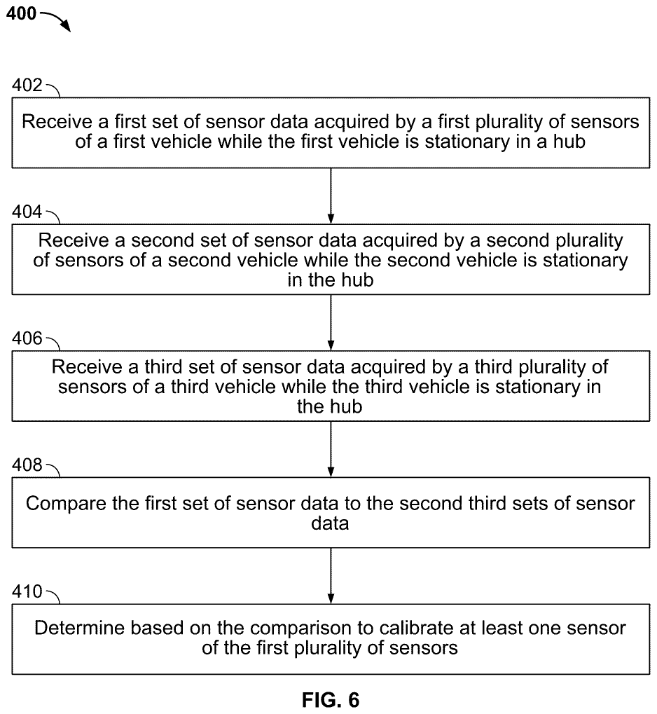

FIG. 6 is a flowchart of a method 400 for calibration of vehicle sensors, according to an example embodiment of the current disclosure. In brief overview, the method 400 can include in 402, receiving from a first plurality of sensors of a first vehicle, a first set of sensor data acquired by the first plurality of sensors while the first vehicle is stationary in a hub. In 404, the method further comprises receiving a second set of sensor data acquired by a second plurality of sensors of a second vehicle while the second vehicle is stationary in the hub. In 406 the method further comprises receiving a third set of sensor data acquired by a third plurality of sensors of a third vehicle while the third vehicle is stationary in the hub. In 408 the method further comprises comparing the first set of sensor data to the second and third sets of sensor data. In 410, the method further comprises determining, based on the comparison of 408, whether to calibrate at least one sensor of the first plurality of sensors using at least one of the second set of sensor data or the third set of sensor data. The first set of sensor data can provide, depict or be generally indicative of a first representation of a hub environment of the hub as perceived by the first plurality of sensors. The second set of sensor data can depict, provide or be generally indicative of a second representation of the hub environment as perceived by the second plurality of sensors. The third set of sensor data can depict, provide or be generally indicative of a third representation of the hub environment as perceived by the third plurality of sensors.

The method 400 can be implemented by a processing device of the vehicle 100, such as the autonomy computing system 200 or the computing system 300. For example, the method 400 can be implemented by the CPU 302 and/or the calibration module 230. In general, the method 400 and other methods for calibration of vehicle sensors described herein can be implemented by an onboard system integrated in the vehicle 100. When the vehicle 100 stops at a hub or some other location associated with a non-controlled environment, the autonomy computing system 200 and/or the calibration module 230 can initiate the sensor calibration method 400 to calibrate the vehicle sensors 202 or a subset thereof. As used herein, a hub can include or can be a location where trucks 100 start and/or end respective rides. In some implementations, a hub can include a resting area for a fleet, or fleets, of vehicles.

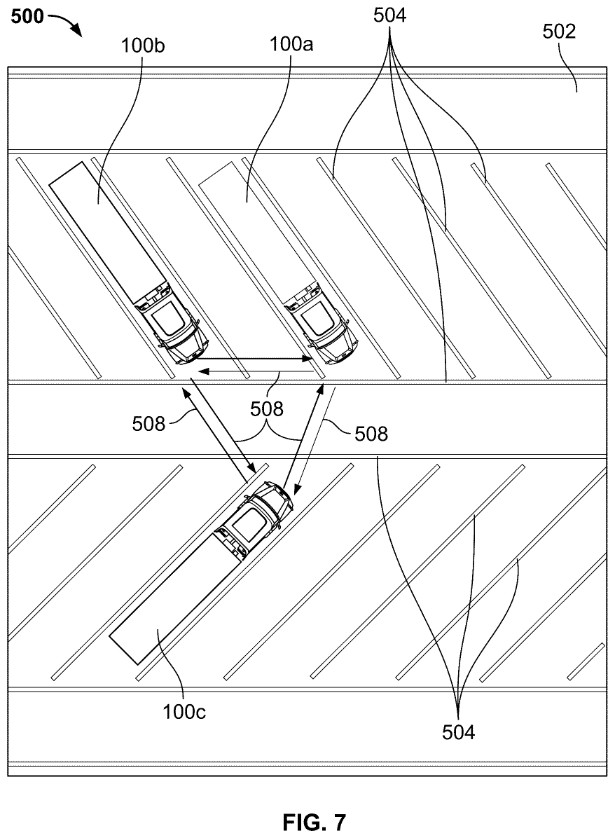

Referring now to FIG. 7, a diagram depicting a hub environment or hub 500 is shown, according to an example embodiment of the current disclosure. The hub 500 can include a parking lot 502 having parking spaces defined by parking stall lines 504. A vehicle 100a can park in one of the parking spaces of the hub 500. Other vehicles, e.g., vehicles 100b and 100c, can be parked at the hub 500 at the same time when vehicle 100a is at the hub 500. The vehicle 100a or the respective autonomy computing system 200 can use sensor data from sensors of vehicle 100a and sensor data from sensors of other vehicles in the hub 500 to determine whether and/or how to calibrate sensors 202 of the vehicle 100a.

Referring now to FIGS. 6 and 7, the method 400 can include the autonomy computing system 200 and/or the calibration module 230 of vehicle 100a receiving from a plurality of sensors 202 of vehicle 100a, a first set of sensor data acquired by the first plurality of sensors 202 while the vehicle 100a is stationary in the hub 500. The plurality of sensors 202 of vehicle 100a can include one or more radar sensors 210, one or LiDAR sensors 212, one or more cameras 214 and/or one or more IMUs 224 among other types of sensors. While vehicle 100a is stationary at the hub 500, the plurality of sensors 202 of vehicle 100a can record various measurements. For example, the sensors 202 can be configured to continuously or periodically record measurements while the vehicle 100a or the respective engine is turned on.

The autonomy computing system 200 and/or the calibration module 230 can detect that the vehicle 100a is at the hub 500, and in response initiate the calibration process 400. For example, vehicles 100 can maintain a list of geolocations for a plurality of hubs. The autonomy computing system 200 of vehicle 100a can detect that vehicle 100a is at one of the hubs based on data from the GNSS receiver 222. In some implementations, a driver of the vehicle 100a can manually initiate or trigger the calibration process 400 via a push-button, a dashboard control and/or a user interface (UI) of the vehicle 100a. In some implementations, the autonomy computing system 200 and/or the calibration module 230 can trigger or initiate the sensor calibration process responsive to detecting that the vehicle 100a is in parking mode. For example, upon detecting that the vehicle 100a is in a parking mode, the autonomy computing system 200 and/or the calibration module 230 can check for nearby vehicles or outside sensor systems from which to receive external sensor data. The autonomy computing system 200 and/or the calibration module 230 can use data from radar sensors 210, LiDAR sensors 212 and/or cameras 214 of vehicle 100a to detect other stationary vehicles in the vicinity of vehicle 100a. The autonomy computing system 200 and/or the calibration module 230 can detect nearby stationary vehicles in the hub 500 based on vehicle-to-vehicle (V2V) wireless communications and/or vehicle-to-everything (V2X) wireless communication between the vehicles.

Initiating the sensor calibration method 400 can include the autonomy computing system 200 and/or the calibration module 230 requesting and/or receiving, from one or more sensors 202 of the vehicle 100a, a first set of sensor data. The first set of sensor data can depict, provide or include, or can be generally indicative of, a first representation of the hub environment 500 as perceived by the sensors 202 of the vehicle 100a. For example, the first set of sensor data can include data recorded by radar sensors 210, data recorded by LiDAR sensors 212 and/or images captured by camera(s) 214 of the vehicle 100a. Each radar sensor 210 can output information about objects detected in the vehicle surrounding including other vehicles. The radar sensor output can include other vehicles'distances from vehicle 100a, speeds, angular positions and/or sizes. In some implementations, each radar sensor 210 can output a point cloud where each point belongs to a detected object, the point's coordinates and the point's velocity information. Each LiDAR sensor 212 can output or provide a respective point cloud representing a detailed three-dimensional (3D) map of the environment of vehicle 100a. The LiDAR sensor 212 can measure distances to various objects, or points thereon, in the environment using laser pulses, and determine the 3D coordinate of each point in the point cloud relative to the LiDAR sensor 212. Each camera 214 can capture one or more images of the vehicle surrounding from a view angle defined by the position, orientation and/or field of view (FOV) of the camera 214. The radar sensors 210, LiDAR sensors 212 and/or cameras 214 can be arranged at different positions in the vehicle 100a, and can have different orientations, different FOVs and/or different ranges.

The first set of sensor data can include information or data indicative of the position(s) and/or orientation(s) of neighboring vehicles, e.g., vehicles 100b and 100c. For example, the first set of sensor data and/or the first representation of the hub environment 500 can include a relative position of vehicle 100b with respect to vehicle 100a, a relative orientation of vehicle 100b with respect to vehicle 100a, a relative position of vehicle 100c with respect to vehicle 100a, and a relative orientation of vehicle 100c with respect to vehicle 100a. The relative positions and/or relative orientations of vehicles 100b and 100c with respect to vehicle 100a can be depicted or included in point cloud(s) generated by the radar sensor(s) 210 and/or point cloud(s) generated by the LiDAR sensor(s) 212 of vehicle 100a.

In some implementations, point cloud data generated by the LiDAR sensor(s) 212 and/or image data captured by the camera(s) 214 can depict the parking stall lines 504. LiDAR sensor(s) 212 can detect the parking stall lines 504 by measuring the reflectivity of the parking lot surface. Parking stall lines 504 typically have a higher reflectivity compared to the surrounding pavement, which allows for their identification in the point cloud data generated by the LiDAR sensor. Parking stall lines 504 can be represented as clusters of points with higher intensity values in the LiDAR data. Image data captured by camera(s) 214 can show at least some of the parking stall lines 504. Depending on the position and orientation of each camera 214 of vehicle 100a, images captured by the camera 214 can show some of the parking stall lines 504.

The method 400 can include the autonomy computing system 200 and/or the calibration module 230 of vehicle 100a receiving a second set of sensor data acquired by sensors 202 of vehicle 100b while the vehicle 100b is stationary in the hub 500, and receiving a third set of sensor data acquired by sensors 202 of vehicle 100c while vehicle 100c is stationary in the hub 500. Vehicles 100a, 100b and 100c can communicate with each other via an external network, such as a cellular network, a local area network, e.g., Wi-Fi associated with the hub 500, and/or some other network type. For example, vehicles 100a, 100b and 100c can communicate with each other via V2V wireless communication. In some implementations, each of the vehicles 100a, 100b and 100c can share sensor data acquired by its sensors 202 with other vehicles and/or other entities using V2X wireless communication.

The second set of sensor data associated with vehicle 100b can depict or include, or can be indicative of, a second representation of the hub environment 500 as perceived by the sensors 202 of vehicle 100b, and the third set of sensor data associated with vehicle 100c can depict, provide or include, or can be generally indicative of, a third representation of the hub environment 500 as perceived by the sensors 202 of vehicle 100c. For example, the second set of sensor data can include point cloud data recorded by radar sensor(s) 210 of vehicle 100b, point cloud data recorded by LiDAR sensor(s) 212 of vehicle 100b and/or image data captured by camera(s) 214 of the vehicle 100b. The point cloud data and/or the image data can include various views of the hub environment 500 depending on the positions and orientations of the radar sensor(s) 210, LiDAR sensor(s) 212 and/or camera(s) of vehicle 100b. The second set of sensor data and/or the second representation of the hub environment 500 can include, can depict or can be indicative of a relative position of vehicle 100a with respect to vehicle 100b, a relative orientation of vehicle 100a with respect to vehicle 100b, a relative position of vehicle 100c with respect to vehicle 100b, and a relative orientation of the vehicle 100c with respect to vehicle 100b. The point cloud data and/or the image data of vehicle 100b can depict the positions of vehicles 100a and 100c in the hub 500. Measurements or point cloud data recorded by the radar sensor(s) 210 and/or the LiDAR sensor(s) 212 of vehicle 100b can include values of distances between the vehicle 100b and vehicles 100a and 100c.

The third set of sensor data can include measurements and/or point cloud data recorded by radar sensor(s) 210 and LiDAR sensors 212 and/or image data captured by camera(s) 214 of the vehicle 100c. The point cloud data and/or the image data can depict various views of the hub environment 500 depending on the positions and orientations of the radar sensor(s) 210, LiDAR sensor(s) 212 and/or camera(s) of vehicle 100c. The third set of sensor data and/or the third representation of the hub environment 500 can include, can depict or can be indicative of a relative position of vehicle 100a with respect to vehicle 100c, a relative orientation of vehicle 100a with respect to vehicle 100c, a relative position of vehicle 100b with respect to vehicle 100c, and a relative orientation of vehicle 100b with respect to vehicle 100c. The point cloud data and/or the image data of vehicle 100c can depict the positions of vehicles 100a and 100b in the hub 500. Measurements and/or point cloud data recorded by the radar sensor(s) 210 and/or the LiDAR sensor(s) 212 of vehicle 100c can include values of distances between the vehicle 100c and vehicles 100a and 100b. The arrows 508 represent signals from sensors of the vehicles 100a, 100b and 100c to sense the vehicle surroundings.

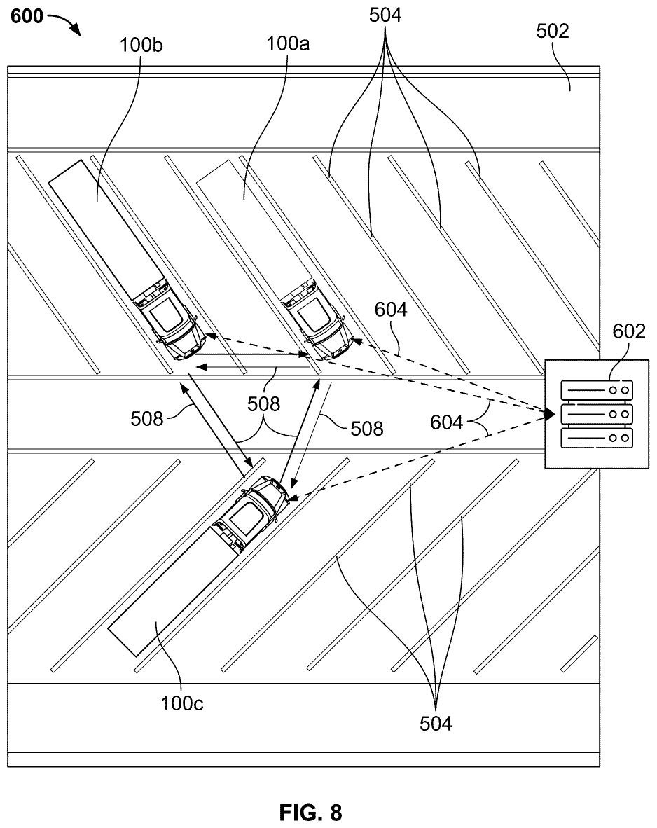

Referring now to FIG. 8, a diagram depicting another hub environment (or hub) 600 is shown, according to an example embodiment of the current disclosure. The hub 600 can be similar to the hub 500, except that the hub 600 can include a computer device 602, e.g., such as a computer server. The computer device 602 can include one or more processors (e.g., similar to CPU 302), a random access memory (e.g., similar to RAM 304), and/or a memory (e.g., similar to memory 306). The computer device 602 can include a network interface controller (e.g., similar to NIC 318) for communicating with a communication network. For example, the computer device 602 can be connected to a local network or Wi-Fi associated with the hub 600. The computer device 602 can be configured to communicate with vehicles 100 in the hub 600. For example, the computer device 602 can receive and store sensor data from vehicles at the hub 600, e.g., vehicles 100a, 100b and/or 100c, before the vehicles are turned off. The computer device 602 can track vehicles 100 as they come and leave the hub 600. For example, the computer device 602 can receive and store sensor data from a vehicle 100, upon the vehicle 100 arriving and parking at the hub 600, and can delete the sensor data upon the vehicle 100 leaving the hub 600. In some implementations, the computer device 602 can monitor or track vehicles 100 parked at the hub 600 and manage storage and/or deletion of sensor data received from separate vehicles 100. In general, the computer device 602 can communicate with vehicles 100a, 100b and 100c via communication links 604 to exchange sensor data.

When vehicle 100a arrives and parks at the hub 600, vehicle 100b and/or vehicle 100c may be turned off. Vehicle 100a may not be able to receive sensor data directly from or communicate with vehicles, e.g., vehicle 100a and/or 100b, that are turned off. In other words, when vehicle 100a arrives and parks at the hub 600, vehicles 100b and 100c may be stationary and parked at the hub 600. However, vehicle(s) 100b and/or 100c may be turned off. The computer device 604 can receive, via communication link(s) 604, the second set of sensor data from vehicle 100b and/or receive the third set of sensor data from vehicle 100c. The autonomy computing system 200 and/or the calibration module 230 of vehicle 100a can receive the second set of sensor data of vehicle 100b and/or the third set of sensor data of vehicle 100c from the computer device 602, e.g., via communication link(s) 604.

The method 400 can include the autonomy computing system 200 and/or the calibration module 230 comparing the first set of sensor data to the second and third sets of sensor data. For example, the autonomy computing system 200 and/or the calibration module 230 can determine, using the first set of sensor data, a relative position of vehicle 100b with respect to vehicle 100a, and determine, using the second set of sensor data, a relative position of vehicle 100a with respect to vehicle 100b. In determining the relative position of vehicle 100b with respect to vehicle 100a, the autonomy computing system 200 and/or the calibration module 230 of vehicle 100a can determine one or more distances between vehicles 100a and 100b and/or the relative orientation of vehicle 100b with respect to vehicle 100a using measurements and/or point cloud data generated by radar sensor(s) 210 and/or LiDAR sensor(s) 212 of vehicle 100a. In determining the relative position of vehicle 100a with respect to vehicle 100b, the autonomy computing system 200 and/or the calibration module 230 of vehicle 100a can determine one or more distances between vehicles 100a and 100b and/or a relative orientation of vehicle 100a with respect to vehicle 100b using measurements and/or point cloud data generated by radar sensor(s) 210 and/or LiDAR sensor(s) 212 of vehicle 100b.

The autonomy computing system 200 and/or the calibration module 230 of vehicle 100a can determine, using the first set of sensor data, a relative position of vehicle 100c with respect to vehicle 100a, and determine, using the third set of sensor data, a relative position of vehicle 100a with respect to vehicle 100c. In determining the relative position of vehicle 100c with respect to vehicle 100a, the autonomy computing system 200 and/or the calibration module 230 of vehicle 100a can determine one or more distances between vehicles 100a and 100c and/or the relative orientation of vehicle 100c with respect to vehicle 100a using measurements and/or point cloud data recorded by radar sensor(s) 210 and/or LiDAR sensor(s) 212 of vehicle 100a. In determining the relative position of vehicle 100a with respect to vehicle 100c, the autonomy computing system 200 and/or the calibration module 230 of vehicle 100a can determine one or more distances between vehicles 100a and 100c and/or a relative orientation of vehicle 100a with respect to vehicle 100c using measurements and/or point cloud data recorded by radar sensor(s) 210 and/or LiDAR sensor(s) 212 of vehicle 100c.

The autonomy computing system 200 and/or the calibration module 230 of vehicle 100a can compare the relative position of vehicle 100b with respect to vehicle 100a to the relative position of vehicle 100a with respect to vehicle 100b, and compare the relative position of vehicle 100c with respect to vehicle 100a to the relative position of vehicle 100a with respect to vehicle 100c. For example, the autonomy computing system 200 and/or the calibration module 230 of vehicle 100a can compare the distance(s) between vehicles 100a and 100b determined using the first set of senor data to the corresponding distance(s) determined using the second set of sensor data, and compare the distance(s) between vehicles 100a and 100c determined using the first set of senor data to the corresponding distance(s) determined using the third set of sensor data. The autonomy computing system 200 and/or the calibration module 230 of vehicle 100a can compare the relative orientation of vehicle 100b with respect to vehicle 100a determined using the first set of senor data to the relative orientation of vehicle 100a with respect to vehicle 100b determined using the second set of senor data. The autonomy computing system 200 and/or the calibration module 230 of vehicle 100a can compare the relative orientation (e.g., as an angle) of vehicle 100c with respect to vehicle 100a determined using the first set of senor data to the relative orientation of vehicle 100a with respect to vehicle 100c determined using the third set of senor data.

The autonomy computing system 200 and/or the calibration module 230 of vehicle 100a can map points and/or features of point cloud data (e.g., generated by radar sensor(s) 210 and/or LiDAR sensor(s) 212) of vehicle 100a to corresponding points and/or features of point cloud data (e.g., generated by radar sensor(s) 210 and/or LiDAR sensor(s)) of vehicle 100b and to corresponding points and/or features of point cloud data (e.g., generated by radar sensor(s) 210 and/or LiDAR sensor(s) 212) of vehicle 100c. It is to be noted that point cloud data of vehicle 100a can have one or more regions in common with point cloud data of vehicle 100b. Also, point cloud data of vehicle 100a can have one or more regions in common with point cloud data of vehicle 100c. For example, one or more portion of the parking lot 502 and one or more parking stall lines 504 can be shown or depicted in point cloud data associated with separate vehicles. The autonomy computing system 200 and/or the calibration module 230 of vehicle 100a can apply point mapping to points and/or features within common region(s) of point cloud data associated with different vehicles, e.g., vehicles 100a and 100b or 100a and 100c. The autonomy computing system 200 and/or the calibration module 230 of vehicle 100a can perform or apply point and/or feature mapping across point cloud data sets associated with distinct vehicles using image processing techniques such as feature detection, epipolar geometry, image stitching and/or matching algorithms among other image processing techniques.

In some implementations, the autonomy computing system 200 and/or the calibration module 230 of vehicle 100a can compare corresponding points and/or corresponding features in point cloud data sets associated with different vehicles. For example, the autonomy computing system 200 and/or the calibration module 230 of vehicle 100a can compare a first distance between a first pair of points or features in point cloud data of vehicle 100a to a second distance between a second pair of points or features, mapped to the first pair of points or features, in point cloud data of vehicle 100b, and/or to a third distance between a third pair of points or features, mapped to the first pair of pixels or features, in point cloud data generated of vehicle 100c. In some implementations, the autonomy computing system 200 and/or the calibration module 230 of vehicle 100a can compare an intensity value of a point or region in point cloud data of vehicle 100a to the intensity value of a corresponding point or region in point cloud data of vehicle 100b and/or to the intensity value of a corresponding point or region in point cloud data of vehicle 100c. In some implementations, the autonomy computing system 200 and/or the calibration module 230 of vehicle 100a can compare other properties of one or more first points or features, e.g., other than intensity values or distances between pairs of points or features, in point cloud data of vehicle 100a to the properties of one or more second points or features, mapped to the one or more first points or features, in point cloud data of vehicle 100b, and/or to the properties of one or more third points or features, mapped to the one or more first points or features, in point cloud data of vehicle 100c.

In some implementations, the autonomy computing system 200 and/or the calibration module 230 of vehicle 100a can map image pixels of image data captured by camera(s) 214 of vehicle 100a to corresponding image pixels of image data captured by camera(s) 214 of vehicle 100b and to corresponding image pixels of image data captured by camera(s) 214 of vehicle 100c. It is to be noted that image data captured by camera(s) 214 of vehicle 100a can have one or more image regions in common with image data captured by camera(s) 214 of vehicle 100b. Also, image data captured by camera(s) 214 of vehicle 100a can have one or more image regions in common with image data captured by camera(s) 214 of vehicle 100c. The autonomy computing system 200 and/or the calibration module 230 of vehicle 100a can apply image pixel mapping to image pixels within common region(s) for image data associated with different vehicles, e.g., vehicles 100a and 100b or 100a and 100c.

To map pixels across image data associated with separate vehicles, the autonomy computing system 200 and/or the calibration module 230 of vehicle 100a can use image processing techniques, such as feature detection, camera calibration, epipolar geometry, image stitching, matching algorithms which help identify corresponding points or features across multiple views, and/or other image processing techniques. For example, for each vehicle of vehicles 100a, 100b and 100c, the autonomy computing system 200 and/or the calibration module 230 of the vehicle (or of vehicle 100a) can stitch images captured by camera(s) 214 of the vehicle to form a panorama view (e.g., with a larger field of view (FOV)) of the hub environment, e.g., hub environment 500 or 600, from the perspective of cameras 214 of the vehicle. In some implementations, each vehicle in the hub 500 or 600, e.g., vehicle 100a, 100b or 100c, can construct and share a respective stitched image representing a respective panorama view of the hub environment 500 or 600 with other vehicles in the hub 500 or 600.

In some implementations, the autonomy computing system 200 and/or the calibration module 230 of vehicle 100a can compare corresponding image pixels and/or corresponding image features in image data sets or images associated with distinct vehicles in the hub 500 or 600. For example, the autonomy computing system 200 and/or the calibration module 230 of vehicle 100a can compare pixel intensity values of a pixel or image region in image data of vehicle 100a to pixel intensity values of a corresponding pixel or image region in image data of vehicle 100b and/or to pixel intensity values of a pixel or image region in image data of vehicle 100c. In some implementations, the autonomy computing system 200 and/or the calibration module 230 of vehicle 100a can compare other image properties, e.g., average intensity or brightness, contrast, sharpness and/or depth of field (DOF) among other properties, of the first image data set to corresponding properties of the second and third image data sets.

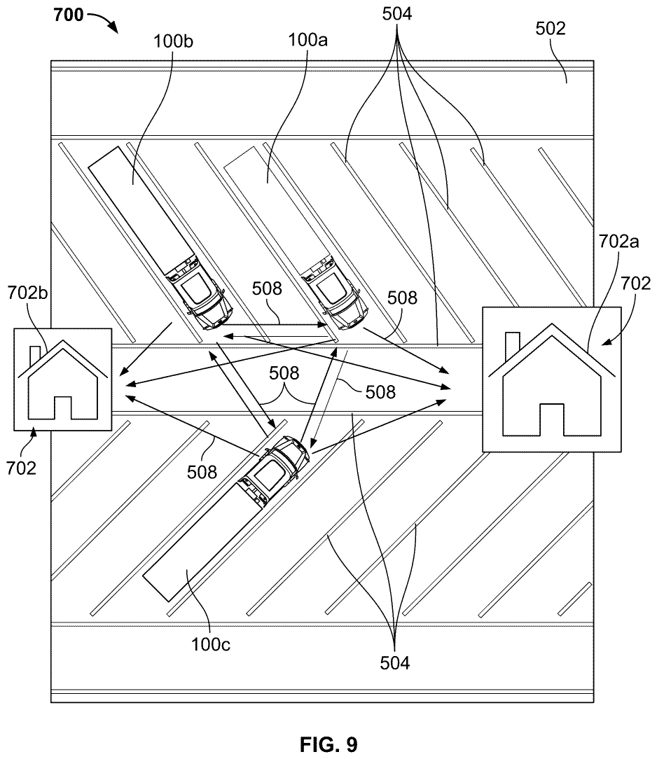

Referring now to FIG. 9, a diagram depicting another hub environment (or hub) 700 is shown, according to an example embodiment of the current disclosure. In some implementations, the hub 700 can include one or more stationary or fixed objects, such as buildings 702a and 702b referred to herein either individually or in combination as building(s) 702. In general, the one or more stationary or fixed objects can include one or more buildings, such as buildings 702a and/or building 702b, one or more signs, one or more posts, one or more fences and/or other type(s) of object(s). The first sensor data of vehicle 100a, the second sensor data of vehicle 100b and/or the third sensor data of vehicle 100c can include information indicative of the shape(s), size(s), color(s) and/or position(s) within the hub 700 of the one or more stationary or fixed objects. For example, image data captured by camera(s) 214 of vehicle 100a, image data captured by camera(s) 214 of vehicle 100b and/or image data captured by camera(s) 214 of vehicle 100c can depict views of the one or more stationary or fixed objects in the hub 700. The point cloud data generated by the radar sensor(s) 210 and/or LiDAR sensor(s) 212 of vehicle 100a, the point cloud data generated by radar sensor(s) 210 and/or the LiDAR sensor(s) 212 of vehicle 100b and/or the point cloud data generated by the radar sensor(s) 210 and/or LiDAR sensor(s) 212 of vehicle 100c can depict, provide or include views of the one or more fixed or stationary objects.

The method 400 can include the autonomy computing system 200 and/or the calibration module 230 of vehicle 100a determining a first position of a stationary object in the hub 700 using the first set of sensor data, determining a second position of the stationary object in the hub 700 using the second set of sensor data, and determining a third position of the stationary object within the hub 700 using the third set of sensor data. For example, the autonomy computing system 200 and/or the calibration module 230 of vehicle 100a can determine, using point cloud data and/or image data of vehicle 100a, a first position of building 702a and/or a first position of building 702b in the hub 700 (e.g., relative to vehicles 100a, 100b and 100c). The autonomy computing system 200 and/or the calibration module 230 of vehicle 100a can determine a second position of building 702a and/or a second position of building 702b in the hub 700 (e.g., relative to vehicles 100a, 100b and 100c) using point cloud data and/or image data of vehicle 100b. The autonomy computing system 200 and/or the calibration module 230 of vehicle 100a can determine a third position of building 702a and/or a third position of building 702b within the hub 700 (e.g., relative to vehicles 100a, 100b and 100c), using point cloud data and/or image data of vehicle 100c.

The autonomy computing system 200 and/or the calibration module 230 of vehicle 100a can compare the first position of the stationary object to the second and third positions of the stationary object. In some implementations, comparing the first position of the stationary object to the second position of the stationary object can include comparing first distances between the stationary object and vehicles 100a, 100b and 100c determined using the first set of sensor data to corresponding second distances between the stationary object and vehicles 100a, 100b and 100c determined using the second set of sensor data. Comparing the first position of the stationary object to the third position of the stationary object can include comparing the first distances between the stationary object and vehicles 100a, 100b and 100c determined using the first set of sensor data to corresponding third distances between the stationary object and vehicles 100a, 100b and 100c determined using the third set of sensor data.

The result(s) of the comparison between the first set of sensor data and the second and/or third sets of sensor data can be indicative of whether the sensors 202, e.g., radar sensor(s) 210, LiDAR sensor(s) 212 and/or camera(s) 214, of vehicle 100a are properly calibrated. The method 400 can include the autonomy computing system 200 and/or the calibration module 230 of vehicle 100a determining, based on the comparison, to calibrate at least one sensor 202 of vehicle 100a. The autonomy computing system 200 and/or the calibration module 230 of vehicle 100a can determine, based on the comparison, to calibrate at least one sensor 202 of vehicle 100a using at least one of the second sensor data or the third sensor data. The autonomy computing system 200 and/or the calibration module 230 of vehicle 100a can compare a parameter value determined using the first set of sensor data to a corresponding parameter value determined using the second set of sensor data and to another corresponding parameter value determined using the third set of sensor data. The parameter value can include or can be a measured value of a distance between a pair of points or objects in the hub 500, 600 or 700, coordinates of an object or vehicle in the hub 500, 600 or 700, an intensity value of an image pixel, an image contrast value or an image brightness value among values of other parameters associated with sensor data acquired by vehicle sensors 202.

The autonomy computing system 200 and/or the calibration module 230 of vehicle 100a can compare a parameter value, e.g., a distance or point coordinates, from point cloud data of vehicle 100a to the corresponding parameter value in point cloud data of vehicle 100b and to the corresponding parameter value in point cloud data of vehicle 100c to determine whether radar sensor(s) 210 and/or LiDAR sensor 212 of vehicle 100a is/are to be calibrated. For example, the autonomy computing system 200 and/or the calibration module 230 of vehicle 100a can compare a distance measured by a radar sensor 210 of vehicle 100a to first corresponding distance(s) measured by radar sensor(s) 210 and/or LiDAR sensor(s) 212 of vehicle 100b and to second corresponding distance(s) measured by radar sensor(s) 210 and/or LiDAR sensor(s) 212 of vehicle 100c. If the distance measured by the radar sensor 210 of vehicle 100a does match the first corresponding distance(s) measured by radar sensor(s) 210 and/or LiDAR sensor(s) 212 of vehicle 100b and the second corresponding distance(s) measured by radar sensor(s) 210 and/or LiDAR sensor(s) 212 of vehicle 100c while the first corresponding distance(s) measured by radar sensor(s) 210 and/or LiDAR sensor(s) 212 of vehicle 100b match (or substantially match within a defined error tolerance range) the second corresponding distance(s) measured by radar sensor(s) 210 and/or LiDAR sensor(s) 212 of vehicle 100c, the autonomy computing system 200 and/or the calibration module 230 of vehicle 100a can determine that the radar sensor 210 of vehicle 100a is out of calibration and is to be recalibrated.

In general, the autonomy computing system 200 and/or the calibration module 230 of vehicle 100a can determine whether sensor data sets from multiple other vehicles in the hub 500, 600 or 700 match or substantially match each other. The autonomy computing system 200 and/or the calibration module 230 of vehicle 100a can using matching sensor data from distinct vehicles, e.g., vehicles 100b and 100c, in the hub 500, 600 or 700 as a reference to calibrate sensors 202 of vehicle 100a. For example, the autonomy computing system 200 and/or the calibration module 230 of vehicle 100a can use matching radar and/or LiDAR data from two or more other vehicles, e.g., vehicles 100b and 100c, to calibrate the radar sensor 210 and/or the LiDAR sensors 212 of vehicle 100a.

In some implementations, the computing system 200 and/or the calibration module 230 of vehicle 100a can calibrate a radar sensor 210 or a LiDAR sensor 212 of vehicle 100a by an offset value determined using the first set of sensor data, the second set of sensor data and/or the third set of sensor data. For example, the computing system 200 and/or the calibration module 230 of vehicle 100a can determine the offset value using differences between values measured by radar sensor(s) 210 and/or LiDAR sensor(s) 212 of vehicle 100a and values measured by radar sensor(s) 210 and/or LiDAR sensor(s) 212 of vehicle 100b, and/or differences between values measured by radar sensor(s) 210 and/or LiDAR sensor(s) 212 of vehicle 100a and values measured by radar sensor(s) 210 and/or LiDAR sensor(s) 212 of vehicle 100c.

The autonomy computing system 200 and/or the calibration module 230 of vehicle 100a can compare a parameter value, e.g., a pixel intensity, image contrast, image sharpness, DOF or image brightness, from image data of vehicle 100a to the corresponding parameter value from image data of vehicle 100b and to the corresponding parameter value from image data of vehicle 100c to determine whether camera(s) 214 of vehicle 100a is/are to be calibrated. For example, the autonomy computing system 200 and/or the calibration module 230 of vehicle 100a can compare one or more image characteristics of one or more images captured by a camera 214 of vehicle 100a to corresponding image characteristic(s) of image(s) captured by camera(s) 214 of vehicle 100b and to corresponding image characteristic(s) of image(s) captured by camera(s) 214 of vehicle 100c. If the one or more image characteristics of the one or more images captured by the camera 214 of vehicle 100a do not match the corresponding image characteristic(s) of image(s) captured by camera(s) 214 of vehicle 100b and the corresponding image characteristic(s) of image(s) captured by camera(s) 214 of vehicle 100c while the corresponding image characteristic(s) of the image(s) captured by camera(s) 214 of vehicle 100b match or substantially match the corresponding image characteristic(s) of the image(s) captured by camera(s) 214 of vehicle 100c, the autonomy computing system 200 and/or the calibration module 230 of vehicle 100a can determine that the camera 214 of vehicle 100a is out of calibration and is to be recalibrated.

In some implementations, the computing system 200 and/or the calibration module 230 of vehicle 100a can use intersection points of parking stall lines 504 (e.g., instead of corner points of a checkerboard pattern) to calculate intrinsic and extrinsic parameters of a camera 214 of vehicle 100a by comparing the coordinates of the intersection points determined using the second and third sets of sensor data to the corresponding coordinates of the intersection points determined using image data of vehicle 100a. The intrinsic parameters of a camera can include the focal length, principal point, and distortion coefficients of the camera. The extrinsic parameters of a camera 214 of vehicle 100a can include the orientation and position of the camera relative to the vehicle 100a. The computing system 200 and/or the calibration module 230 of vehicle 100a can determine to calibrate the intrinsic and/or extrinsic parameters of the camera 214 of vehicle 100a based on the comparison. In other words, if the coordinates of the intersection points determined using the second set of sensor data match or substantially match the coordinates of the intersection points determined using the third set of sensor data but both do not match the coordinates of the intersection points determined using the first set of sensor data, the computing system 200 and/or the calibration module 230 of vehicle 100a can determine that the intrinsic and/or extrinsic parameters of the camera 214 of vehicle 100a is out of calibration and is to be calibrated.

While embodiments described above relate to using sensor data from two other vehicles, e.g., vehicles 100b and 100c, the vehicle 100a can receive sensor data from two or more other vehicles. If there is a match between sets of sensor data from multiple vehicles, the computing system 200 and/or the calibration module 230 of vehicle 100a can determine that the sensors of the multiple vehicles, with respective matching sets of sensor data, are calibrated, and can use the sets of sensor data of the multiple vehicles to determine whether the sensors of vehicle 100a calibrate are out of calibration and are to be calibrated. The computing system 200 and/or the calibration module 230 of vehicle 100a can calibrate the sensors 202 of vehicle 100a using the sets of sensor data of the multiple vehicles. In some implementations, the computing system 200 and/or the calibration module 230 of vehicle 100a can determine a confidence score for the determination of whether or not the sensors 202 of vehicle 100a are out of calibration. The confidence score can depend on the number of vehicles in the hub 500, 600 or 700 with matching or substantially matching sensor data.

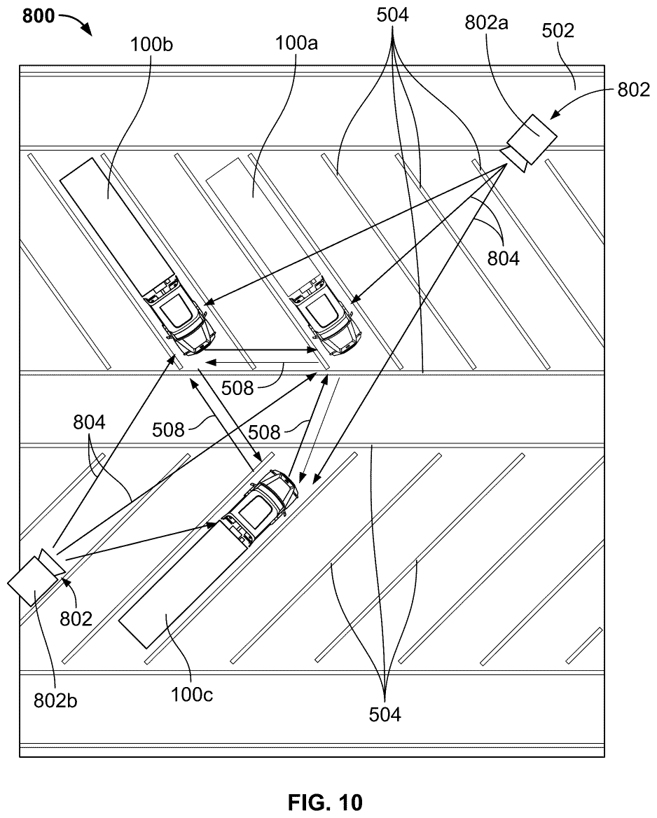

Referring now to FIG. 10, a diagram depicting another hub environment 800 is shown, according to an example embodiment of the current disclosure. In some implementations, the hub 800 can include one or more sensors, such as sensors 802a and/or 802b. The hub sensors 802a and 802b are referred to herein, either individually or in combination, as senor(s) 802. The sensor(s) 802 can include one or more cameras, one or more LiDAR sensors and/or one or more radar sensors arranged at stationary positions in the hub 800. For example, the sensors 802 can include a plurality of cameras arranged at different positions to capture images representing different views of the hub 800. In some implementations, the sensors 802 can include a plurality of LiDAR sensors to generate point cloud data sets of the hub environment 800 associated with different view angles. In some implementations, the hub 800 can include one or more fixed or stationary radar sensors to generate point cloud data sets of the hub environment 800 associated with different view angles. The arrows 804 represent signals emitted by the hub sensors 802 to sense the hub environment 800 and/or objects therein, such as vehicles 100a, 100b and 100c.

In some implementations, the method 400 can include the computing system 200 and/or the calibration module 230 of vehicle 100a receiving a fourth set of sensor data acquired by the sensor(s) 802 of the hub 800, and compare the first set of sensor data of vehicle 100a to the fourth set of sensor data recorded by the hub sensors 802. The fourth set of sensor data acquired by the sensor(s) 802 can depict a fourth representation of the hub environment 802 as perceived by the sensors 802. The computing system 200 and/or the calibration module 230 of vehicle 100a can determine, based on comparing the first set of sensor data to the fourth set of sensor data, to calibrate at least one sensor 202 of vehicle 100a. In some implementations, the fourth set of sensor data and/or the representation of the hub environment 800 can include or depict, or can be indicative of, relative positions of vehicles 100a, 100b and 100c with respect to each other.

The computing system 200 and/or the calibration module 230 of vehicle 100a can compare the first set of sensor data to the fourth set of sensor data as described above in relation to the comparing the first set of sensor data to the second and third sets of sensor data. In some implementations, the computing system 200 and/or the calibration module 230 of vehicle 100a can use only the fourth set of sensor data (e.g., without other sets of sensor data from other vehicles, such as vehicles 100b and 100c) to determine whether or not to calibrate the sensors of vehicle 100a. In some implementations, the computing system 200 and/or the calibration module 230 of vehicle 100a can use the fourth set of sensor data together with other sets of sensor data from other vehicles, such as vehicles 100b and 100c, to determine whether or not to calibrate the sensors of vehicle 100a.

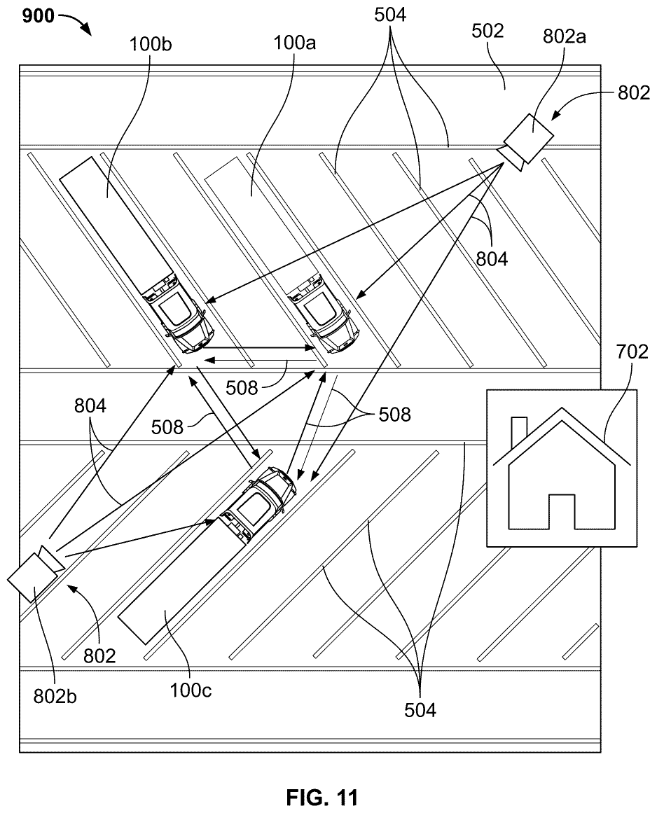

Referring now to FIG. 11, a diagram depicting another hub environment 900 is shown, according to an example embodiment of the current disclosure. The hub 900 can include one or more stationary objects, such as building 702, and one or more hub sensors 802. In other words, the hub 900 can be viewed as a combination of hub 700 and hub 800. The sensor(s) 802 can provide a fourth set of sensor data depicting a representation of the hub environment 900. In some implementations, the fourth set of sensor data and/or the representation of the hub environment 900 can include or depict, or can be indicative of relative positions of vehicle(s) 100a, 100b and/or 100c with respect to a stationary object in the hub 900. For example, the fourth set of sensor data and/or the representation of the hub environment 900 can include or depict, or can be indicative of, relative positions of vehicle(s) 100a, 100b and/or 100c with respect to building 702

As discussed above in relation to FIG. 10, the computing system 200 and/or the calibration module 230 of vehicle 100a can use only the fourth set of sensor data (e.g., without other sets of sensor data from other vehicles, such as vehicles 100b and 100c) or can use the fourth set of sensor data together with other sets of sensor data from other vehicles, such as vehicles 100b and 100c, to determine whether or not to calibrate the sensors of vehicle 100a.

In some implementations, the computing system 200 and/or the calibration module 230 of vehicle 100a can select stationary objects of the hub 700 and/or 900 to be considered in determining whether or not to calibrate senor(s) 202 of vehicle 100a. For example, the computing system 200 and/or the calibration module 230 of vehicle 100a can ignore trees, bushes and/or plants in the hub 700 and/or 900 because they may exhibit some movements and may lead to inaccurate determination. In some implementations, the computing system 200 and/or the calibration module 230 of vehicle 100a can check weather conditions, e.g., based on information from the Internet or an exterior source, and determine whether to execute a calibration process based on the weather conditions. For example, if it is windy, foggy, raining and/or snowing, the computing system 200 and/or the calibration module 230 of vehicle 100a may decide not to initiate the sensor calibration process.

In some implementations, the computing system 200 and/or the calibration module 230 of vehicle 100a can determine whether the sensor(s) 202 of vehicle 100a is/are out of calibration, and send information indicative of the determination to a remote computer system and/or cause display of the indication of the determination on a display device vehicle 100a. In some implementations, the computing system 200 and/or the calibration module 230 of vehicle 100a can calibrate the sensor(s) of vehicle 100a using sensor data from other vehicles, e.g., vehicles 100b and 100c, and/or sensor data from hub sensor(s) 802.

In general, the computing system 200 and/or the calibration module 230 of vehicle 100a can calibrate sensors 202 of vehicle 100a based on sensor data from one or more other vehicles in the hub and/or sensor data from hub sensors 802. For example, the computing system 200 and/or the calibration module 230 of vehicle 100a can use only sensor data from hub sensors 802 to calibrate sensors 202 of vehicle 100a. The computing system 200 and/or the calibration module 230 of vehicle 100a can use sensor data from hub sensors 802 and sensor data from one or more other vehicles in the hub to calibrate sensors 202 of vehicle 100a. The computing system 200 and/or the calibration module 230 of vehicle 100a can use sensor data from multiple (e.g., two or more) other vehicles in the hub to calibrate sensors 202 of vehicle 100a. The sensor calibration can be performed as discussed above.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A system for calibration of vehicle sensors, the system comprising:
a first plurality of sensors of a first vehicle to sense a surrounding of the first vehicle; and
a processing device in communication with the first plurality of sensors, the processing device is configured to execute instructions stored in a memory to:
receive, from the first plurality of sensors of the first vehicle, a first set of sensor data acquired by the first plurality of sensors while the first vehicle is stationary in a hub, the first set of sensor data providing a first representation of a hub environment of the hub as perceived by the first plurality of sensors;
receive a second set of sensor data acquired by a second plurality of sensors of a second vehicle while the second vehicle is stationary in the hub, the second set of sensor data providing a second representation of the hub environment as perceived by the second plurality of sensors;
receive a third set of sensor data acquired by a third plurality of sensors of a third vehicle while the third vehicle is stationary in the hub, the third set of sensor data providing a third representation of the hub environment as perceived by the third plurality of sensors;
compare the first set of sensor data to the second and third sets of sensor data; and
determine, based on the comparison, to calibrate at least one sensor of the first plurality of sensors using at least one of the second set of sensor data or the third set of sensor data.

2. The system of claim 1, wherein the first representation of the hub environment includes:
a relative position of the second vehicle with respect to the first vehicle;
a relative orientation of the second vehicle with respect to the first vehicle;
a relative position of the third vehicle with respect to the first vehicle; and
a relative orientation of the third vehicle with respect to the first vehicle.

3. The system of claim 1, wherein the second representation of the hub environment includes:
a relative position of the first vehicle with respect to the second vehicle;
a relative orientation of the first vehicle with respect to second vehicle;
a relative position of the third vehicle with respect to the second vehicle; and
a relative orientation of the third vehicle with respect to the second vehicle.

4. The system of claim 1, wherein the third representation of the hub environment includes:
a relative position of the first vehicle with respect to the third vehicle;
a relative orientation of the first vehicle with respect to the third vehicle;
a relative position of the second vehicle with respect to the third vehicle; and
a relative orientation of the second vehicle with respect to third vehicle.

5. The system of claim 1, wherein the processing device is configured to:
determine, using the first set of sensor data, a first relative position of the second vehicle with respect to the first vehicle;
determine, using the first set of sensor data, a second relative position of the third vehicle with respect to the first vehicle;
determine, using the second set of sensor data, a third relative position of the first vehicle with respect to the second vehicle;
determine, using the third set of sensor data, a fourth relative position of the first vehicle with respect to the third vehicle; and
compare the first relative position to the third relative position and the second relative position to the fourth relative position.

6. The system of claim 1, wherein the processing device is configured to:
determine, using the first set of sensor data, a first position of a stationary object in the hub;
determine, using the second set of sensor data, a second position of the stationary object in the hub;
determine, using the third set of sensor data, a third position of the stationary object in the hub; and
compare the first position to the second and third positions of the stationary object.

7. The system of claim 1, wherein the processing device is configured to:
receive a fourth set of sensor data acquired by a fourth plurality of sensors of the hub, the fourth set of sensor data providing a fourth representation of the hub environment as perceived by the fourth plurality of sensors;
compare the first set of sensor data to the fourth set of sensor data; and
determine, further based on comparing the first set of sensor data to the fourth set of sensor data, to calibrate the at least one sensor of the first plurality of sensors.

8. The system of claim 7, wherein the fourth representation of the hub environment includes at least one of:
relative positions of the first, second and third vehicles with respect to each other; or
relative positions of the first, second and third vehicles with respect to a stationary object in the hub.

9. The system of claim 1, wherein the processing device is configured to:
receive the second set of sensor data from a computer device of the hub, the computer device receiving the second set of sensor data from the second vehicle.

10. The system of claim 1, wherein the first plurality of sensors includes at least one of:
one or more radar sensors;
one or more light detection and raging (LiDAR) sensors; or one or more cameras.

11. A method for calibration of vehicle sensors, the method comprising:
receiving, by a processing device of a first vehicle, from a first plurality of sensors of the first vehicle, a first set of sensor data acquired by the first plurality of sensors while the first vehicle is stationary in a hub, the first set of sensor data providing a first representation of a hub environment of the hub as perceived by the first plurality of sensors;
receiving, by the processing device, a second set of sensor data acquired by a second plurality of sensors of a second vehicle while the second vehicle is stationary in the hub, the second set of sensor data providing a second representation of the hub environment as perceived by the second plurality of sensors;
receiving, by the processing device, a third set of sensor data acquired by a third plurality of sensors of a third vehicle while the third vehicle is stationary in the hub, the third set of sensor data providing a third representation of the hub environment as perceived by the third plurality of sensors;
comparing, by the processing device, the first set of sensor data to the second and third sets of sensor data; and
determining, by the processing device, based on the comparison, to calibrate at least one sensor of the first plurality of sensors using at least one of the second set of sensor data or the third set of sensor data.

12. The method of claim 11, wherein the first representation of the hub environment includes:
a relative position of the second vehicle with respect to the first vehicle;
a relative orientation of the second vehicle with respect to the first vehicle;
a relative position of the third vehicle with respect to the first vehicle; and
a relative orientation of the third vehicle with respect to the first vehicle.

13. The method of claim 11, wherein the second representation of the hub environment includes:
a relative position of the first vehicle with respect to the second vehicle;
a relative orientation of the first vehicle with respect to the second vehicle;
a relative position of the third vehicle with respect to the second vehicle; and
a relative orientation of the third vehicle with respect to the second vehicle.

14. The method of claim 11, wherein the third representation of the hub environment includes:
a relative position of the first vehicle with respect to the third vehicle;
a relative orientation of the first vehicle with respect to the third vehicle;
a relative position of the second vehicle with respect to the third vehicle; and
a relative orientation of the second vehicle with respect to the third vehicle.

15. The method of claim 11, comprising:
determining, using the first set of sensor data, a first relative position of the second vehicle with respect to the first vehicle;
determining, using the first set of sensor data, a second relative position of the third vehicle with respect to the first vehicle;
determining, using the second set of sensor data, a third relative position of the first vehicle with respect to the second vehicle;
determining, using the third set of sensor data, a fourth relative position of the first vehicle with respect to the third vehicle; and
comparing the first relative position to the third relative position and the second relative position to the fourth relative position.

16. The method of claim 11, comprising:
determining, using the first set of sensor data, a first position of a stationary object in the hub;
determining, using the second set of sensor data, a second position of the stationary object in the hub;
determining, using the third set of sensor data, a third position of the stationary object in the hub; and
comparing the first position to the second and third positions of the stationary object.

17. The method of claim 11, comprising:
receiving a fourth set of sensor data acquired by a fourth plurality of sensors of the hub, the fourth set of sensor data providing a fourth representation of the hub environment as perceived by the fourth plurality of sensors;
comparing the first set of sensor data to the fourth set of sensor data; and
determining, further based on comparing the first set of sensor data to the fourth set of sensor data, to calibrate the at least one sensor of the first plurality of sensors.

18. The method of claim 17, wherein the fourth representation of the hub environment includes at least one of:
relative positions of the first, second and third vehicles with respect to each other; or
relative positions of the first, second and third vehicles with respect to a stationary object in the hub.

19. The method of claim 11, comprising:
receiving the second set of sensor data from a computer device of the hub, the computer device receiving the second set of sensor data from the second vehicle.

20. The method of claim 11, wherein the first plurality of sensors includes at least one of:
one or more radar sensors;
one or more light detection and raging (LiDAR) sensors; or one or more cameras.
